(19) United States
(12) Patent Application Publication
(10) Pub. No.: US 2002/0138451 A1
(43) Pub. Date: Sep. 26, 2002

(54) Postage meter machine with a data transmission device

(75) Inventor: Graham Roderick Lodge, Needingworth (GB)

Correspondence Address: SCHIFF HARDIN & WAITE, 6600 SEARS TOWER, 233 S WACKER DR, CHICAGO, IL, 60606-6473, US

(73) Assignee: Francotyp-Postalia AG & Co. KG

(21) Appl. No.: 10/074,838

(22) Filed: Feb. 13, 2002

(30) Foreign Application Priority Data
Mar. 21, 2001 (DE) 101 14 533.0

(51) Int. Cl. G06F 17/60

(52) U.S. Cl. 705/401; 705/60

(57) ABSTRACT

In a postage meter machine, a method for the operation of a postage meter machine as well as method for data communication between a postage meter machine and a remote data center, the postage meter machine has a central processing device and a data transmission device connected thereto for the transmission of information between the processing device and the remote data center via a telecommunication network. The data transmission device has a connection unit for making the connection to a telecommunication line of the telecommunication network. A monitoring device in the postage meter machine monitors the usage status of the telecommunication line.

### BACKGROUND OF THE INVENTION

1. Field of the Invention

The present invention is directed to a postage meter machine of the type having a central processing device and a data transmission device connected thereto for transmitting of information between the processing device and a remote data center via a telecommunication network, the data transmission device having means for making the connection to a telecommunication line of the telecommunication network. The invention is also directed to a system having at least one postage meter machine of this type and a remote data center connectable thereto via a telecommunication network. The invention is also directed to a method for the operation of a postage meter machine of this type as well as to a method for data communication between a postage meter machine of this type and a remote data center.

2. Description of the Prior Art

In postage meter machines, those registers that contain the total postage value still available for franking imprints are regularly replenished (refilled) in order to enable a continuous operation. This conventionally occurs via a modem of the postage meter machine with which a connection can be set up to a remote data center. The postage replenishing then ensues following the connection set up according to specific, predetermined refilling protocols that must meet strict security standards.

Conventional postage meter machines are usually designed for a relatively large volume of mail sent by a company or the like, so that they are usually in a separate mail room location having a separate connection to a telephone network. Accordingly, their modems are usually designed for a separate telephone connection.

Postage meter machines are also offered for smaller volumes of mail such as, for example, for smaller offices or the like. As a rule, however, the same type of modem as already described above is utilized for these machines.

In smaller offices or at home workstations, however, there is often the problem that no separate telephone connection having a separate telephone line for the modem of the postage meter machine is available; rather, other telecommunication devices such as, for example, telefax, telephone and computer with Internet access are connected to a single telephone line at a multiple connection, in addition to the modem of the postage meter machine. Even when the telephone line, as in the case of a conventional ISDN connection, makes a number (usually only two or three) of channels available that can be used in parallel with one another, this results in the possibility that, dependent on the priority of the plug-locations available, the telephone line can be blocked over a longer time due to a postage refilling operation of the postage meter machine. It is likewise possible that an ongoing telephone call or an ongoing fax transmission, etc., may be interrupted by the postage meter machine under certain circumstances, when the postage meter machine attempts to set up a connection to the data center.

### SUMMARY OF THE INVENTION

An object of the present invention is to provide a postage meter machine, a method for the operation of a postage meter machine as well as a method for data communication between a postage meter machine and a remote data center of the type initially described, wherein the aforementioned disadvantages do not occur, or occur at least to a lesser extent, and which, in particular, are suitable for the common utilization of the postage meter machine together with other telecommunication devices at a shared telecommunication line.

The above object is achieved in accordance with the invention in a postage meter machine suitable for operation together with a telecommunication device connected to the same telecommunication line, the postage meter machine having a monitoring device for monitoring the usage status of the telecommunication line.

With this monitoring device, it is possible to prevent, first, existing connections of the other devices at the telecommunication line from being interrupted by a connection set up or a set up attempt by the data transmission device of the postage meter machine. Second, it is possible to interrupt an existing connection between the postage meter machine and the data center in order, for example, to activate an urgent call, for example an emergency call, via a telephone connected to the same telecommunication line.

In preferred versions of the inventive postage meter machine, the monitoring device is fashioned such that, given use of the telecommunication line by a first telecommunication device connected thereto, a connection setup via the telecommunication network is suppressed in order to preclude interruption of the existing connection by the postage meter machine.

The suppression of a connection setup can ensue in a number of ways. For example, the monitoring device can simply drive a corresponding switch or the like that interrupts the connection between the data transmission device and the telecommunication line or the processing device. In preferred versions, the monitoring device generates a suppression signal that is forwarded to a further device of the postage meter machine that effects the suppression of the connection setup when the suppression signal is present. Thus, for example, the suppression of the connection setup can be achieved by the data transmission device being enabled to only start a connection setup when no suppression signal is present.

Preferably, however, the suppressed signal is forwarded to the processing device wherein it is suitably processed. For example, the processing device may instruct the data transmission device to set up a connection to the data center only when no suppress signal from the monitoring device is present.

The monitoring of the usage status of the telecommunication line can ensue continuously, i.e. uninterrupted, or at predetermined time intervals. Of course, alternatively, the monitoring may ensue only when a connection setup is to be attempted between the postage meter machine and the data center.

In other embodiments of the inventive postage meter machine, the monitoring device is fashioned for recognizing an attempt at a connection setup via the telecommunication line by a first telecommunication device connected to the telecommunication line, at least given use of the telecommunication line by the data transmission device. As a result of the invention recognizing when a first telecommunication device connected to the telecommunication line attempts to setup a connection, it is possible to interrupt an existing connection between the postage meter machine and the data center in case of such an attempt, in order to assure that the telecommunication line is not blocked by the postage meter machine in urgent situations, for example in emergencies. Advantageously, the user need not personally interrupt the connection between postage meter machine and data center; rather, this occurs automatically.

The recognition of such a connection setup attempt preferably ensues—continuously or at a defined frequency—during a time in which the postage meter machine is connected to the data center. This recognition itself can ensue continuously, i.e. uninterrupted, or at predetermined time intervals.

The interruption of a connection between postage meter machine and the data center can ensue in a number of ways. The monitoring device can, for example, simply drive a corresponding switch or the like that interrupts the connection between the data transmission device and the telecommunication line or the processing device. In preferred versions, the monitoring device is fashioned for generating a first interrupt signal that is then forwarded to a further device of the postage meter machine that in turn effects the interruption of the connection when the interrupt signal is preset. Thus, for example, the interruption of the connection can be realized by the data transmission device aborting the connection when a first interrupt signal is preset.

The monitoring device preferably forwards the first interrupt signal to the processing device. As a result, a controlled abort of the connection is possible wherein, in particular, it can be assured that no important data, for example security-relevant data, are lost.

In order to further reduce the risk of such a data loss, in preferred versions of the invention, a second interrupt signal is forwarded to the data center before the connection is interrupted. This second interrupt signal can be generated by the device to which the first interrupt signal is handed over. For example, it can be generated by the data transmission device itself or by the processing device. The generation of the second interrupt signal by the processing device has the advantage that the interrupt signal also can contain further information, for example related to the status of the data transmission. In further, quickly reacting versions, the monitoring device can generate the second interrupt signal and communicate it to the data center. The second interrupt signal can correspond to the first interrupt signal.

The invention is also directed to a system having at least one inventive postage meter machine as described above and a remote data center connectable to the postage meter machine via a telecommunication line of a telecommunication network. The above-described advantages and effects are achieved in the same way with such a system.

In a preferred embodiment of the inventive system, the postage meter machine has a monitoring device for acquiring an attempt at a connection setup via the communication line by a telecommunication device connected to the telecommunication line, this being fashioned for generating an interrupt signal. The postage meter machine is also fashioned for forwarding a second interrupt signal to the data center before interrupting the connection to the data center. The data center is in turn fashioned for the transmission—dependent on the interrupt signal—of specific data given a subsequent connection setup to the postage meter machine.

As a result, it is possible to register (note) an incomplete data transmission in the data center as a consequence of the premature interruption of the connection and to either complete or, preferably, to repeat the data transmission when a subsequent connection setup—preferably the next connection setup—is made between postage meter machine and data center. This is particularly important in conjunction with the postage refilling event wherein, first, it must be assured that the account of the user of the postage meter machine is not incorrectly charged since the refilling event was not able to be concluded as a consequence of the premature interruption, and the registers of the postage meter machine thus were not refilled. Second, it is assured that no discrepancies occur between the values of the postal registers and other memories of the postage meter machine and the data stored with respect thereto in the data center.

The same advantages and effects are achieved with an inventive method for data communication between a postage meter machine and a remote data center connectable to the postage meter machine via a telecommunication line of a telecommunication network, wherein an attempt at a connection setup via the telecommunication line by a first telecommunication device connected to the telecommunication line is recognized by a monitoring device of the postage meter machine, a second interrupt signal is generated in response thereto and is forwarded to the data center before the connection to the data center is subsequently interrupted, and, finally, the data center communicates specific data dependent on the interrupt signal in a subsequent connection setup to the postage meter machine.

### DESCRIPTION OF THE DRAWINGS

FIG. 1 is a block circuit diagram of a preferred embodiment of the inventive system having an inventive postage meter machine.

FIG. 2 is a flow chart of a preferred version of the inventive method.

FIG. 3 is a flow chart of another preferred version of the inventive method.

### DESCRIPTION OF THE PREFERRED EMBODIMENTS

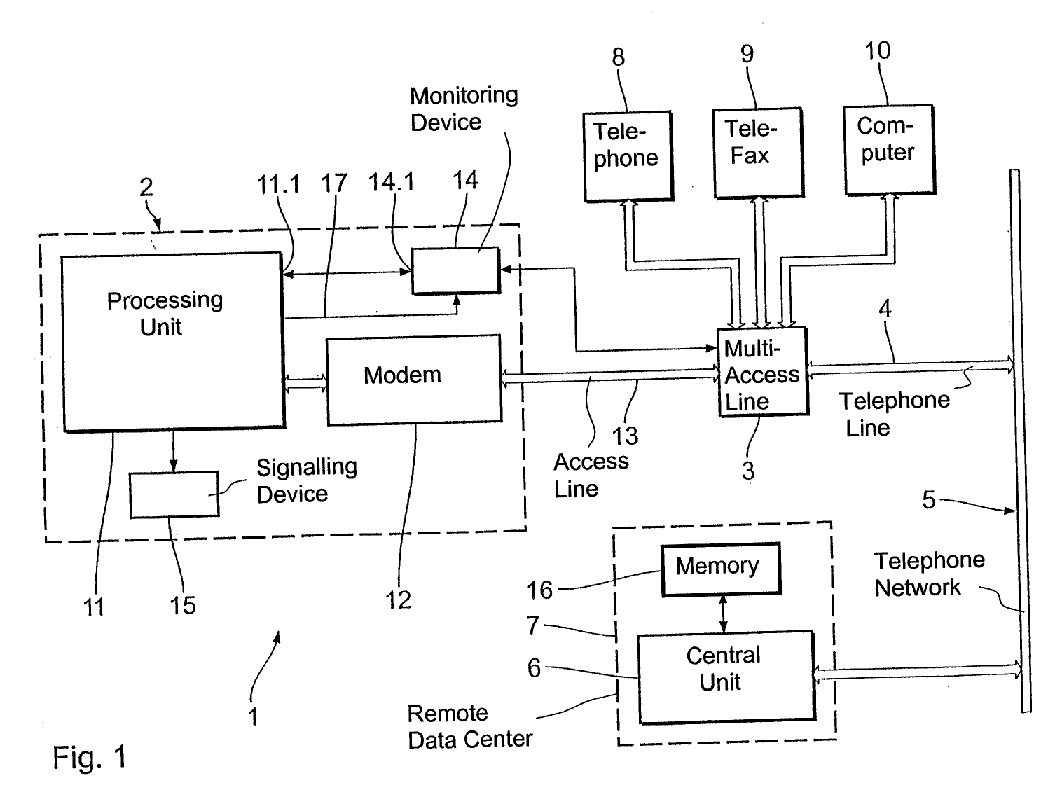

FIG. 1 shows a block circuit diagram of a preferred embodiment of the inventive system 1 with an inventive postage meter machine 2 that is connected to a telecommunication line in the form of a telephone line 4 of a telephone network 5 via a line unit in the form of a multi-access line 3. The postage meter machine 2 thus can be connected to the central unit 6 of a remote data center 7 via the telephone network 5.

In addition to the postage meter machine 2, further telecommunication devices are also connected to the multi-access line 3, namely a telephone 8, a telefax machine 9 and a computer 10 having a data transmission device for access to the Internet or the like.

Among other components, the postage meter machine 2 has a central processing unit 11 and a data transmission device connected thereto in the form of a modem 12 that is in turn connected via connection in the form of an access line 13 to the multi-access line 3. The postage meter machine 2 also has a monitoring device 14 connected to the processing unit 11 and to the multi-access line 3.

The monitoring device 14 serves for monitoring the usage status of the telephone line 4, this being, for example, an ISDN line having two channels useable in parallel with one another. The modem 12 is allocated to one of the two channels of the telephone line 4 useable in parallel and to which the telephone 8 is additionally allocated. The monitoring device 14 monitors the usage status of this channel of the telephone line 4.

In a first constellation wherein a connection setup between the postage meter machine 2 and the data center 7 is to be attempted, a first status that represents a suppression signal UDS is present at the output 14.1 of the monitoring device 14, and thus at the input 11.1 of the processing unit 11 as well, when the appertaining channel of the telephone line 4 is being used. When the suppression signal UDS is present at the input 11.1 of the processing unit 11, the processing unit 11 is prevented from initiating a connection setup to the central unit 6 of the data center 7. In other words, the processing unit 11 addresses the modem 12 to setup a connection to the data center 7 only when no suppression signal UDS of the monitoring device 14 is present.

This prevents an existing connection of the telephone 8 allocated to the same channel from being interrupted by the attempt at a connection setup to the central unit 6 of the data center 7.

In a second constellation wherein a connection already exists between the postage meter machine 2 and the data center 7, the monitoring device 14 likewise monitors the usage status of the appertaining channel of the telephone line 4. In this second constellation, the monitoring device 14 detects whether an attempt is being made by the telephone 8 to set up a connection via the telephone network. If this is the case, a second status that represents a first interrupt signal UBS1 is present at the output 14.1 of the monitoring device 14, and thus at the input 11.1 of the processing unit 1 as well.

When the first interrupt signal UBS1 is present at the input 11.1 of the processing unit 11, the processing unit 1 is first initiated to generate a second interrupt signal UBS2 and to send this to the central unit 6 of the data center 7 via the still-existing connection. Subsequently, the processing unit 11 causes the modem 12 to abort the connection to the data center 7.

This assures that an existing connection between the postage meter machine 2 and the data center 7 is automatically interrupted in order to initiate an urgent call, for example an emergency call, via the telephone 8.

In order to assure that the connection between the postage meter machine 2 and the data center 7 is not unintentionally interrupted, the postage meter machine 2 has an acoustic signaling device 15 that is driven by the processing unit 11 after the first interrupt signal UBS 1 is present, to inform the user of the telephone 8 that the user is in the process of interrupting an existing connection between the postage meter machine 2 and the data center 7.

The interruption of the connection between the postage meter machine 2 and the data center ensues somewhat time-delayed, namely only when the monitoring device 14 still detects a connection setup attempt, i.e. the first interrupt signal UBS1 is still present at the input 11.1, after a predetermined time span, for example 5 s, that can be set by the user at the postage meter machine 2. This makes it possible for the user of the telephone 8 to abort the connection setup, i.e. to hang up, without an interruption of the connection between the postage meter machine 2 and the data center 7 occurring.

The signal device can be realized in some other way in other versions of the present invention, for example as an optical signal device or an optical and acoustic signal device. With suitable networking, the signal device can be integrated in the other telecommunication device, i.e. for example, in the telephone 8, and, driven by the postage meter machine 2, emits a corresponding signal, for example an alarm tone or a voice message to the user of the other telecommunication device. Such a signal device, however, can be omitted and an automatic abort can ensue without warning.

The forwarding of the first interrupt signal UBS1 to the processing unit enables a controlled abort of the connection between the postage meter machine 2 and the data center 7 wherein it can be assured that no important data, for example security-relevant data, are lost.

The risk of such a data loss is reduced further by the second interrupt signal UBS2 sent to the central unit 6 of the data center 7. This second interrupt signal UBS2 contains information with respect to the status of the interrupted data transmission. This second interrupt signal UBS2 is stored in a memory device 16 connected to the central unit 6 of the data center 7, whereby it is unambiguously allocated to the postage meter machine 2. This memory device 16 is accessed at every communication with the postage meter machine 2. Dependent on whether such a second interrupt signal UBS2 was stored in the last connection to the postage meter machine 2, the central unit 6 in the next connection setup to the postage meter machine 2 repeats the data transmission that was aborted in the previous attempt.

As a result, an incomplete data transmission due to a premature interruption of the connection is registered in the data center 7 and the data transmission is repeated on the occasion of the next connection setup between postage meter machine 2 and data center 7. This is particularly significant in conjunction with the postage refilling event wherein it must be assured that the account of the postage meter machine user is not unjustifiably charged, since the refilling event was not able to be concluded as a consequence of the premature interruption, and the registers of the postage meter machine 2 thus were not correspondingly refilled. Second, it is assured that no discrepancy occurs between the values of the postal registers (not shown) and other memories of the postage meter machine 2 and the data stored with respect thereto in the data center 7.

In the illustrated example, the monitoring of the usage status of the appertaining channel of the telephone line 4 ensues only in the two constellations when—in the first constellation—a connection setup is to be attempted between the postage meter machine 2 and the data center 7 or when—given the second constellation—a connection already exists between the postage meter machine 2 and the data center 7. To this end, the monitor device 14 is correspondingly driven by the processing unit 11 via the control line 17. In the second constellation, the initiated monitoring then ensues at short time intervals.

The first status and second status of the output 14.1 of the monitoring device 14, moreover, can be different or can be the same status in the simplest case, this then being correspondingly interpreted by the processing unit as the suppression signal UDS when a connection setup is being attempted at the moment, or as a first interrupt signal UBS1 when a transmission is ongoing at the moment or a connection to the data center exists or is being setup.

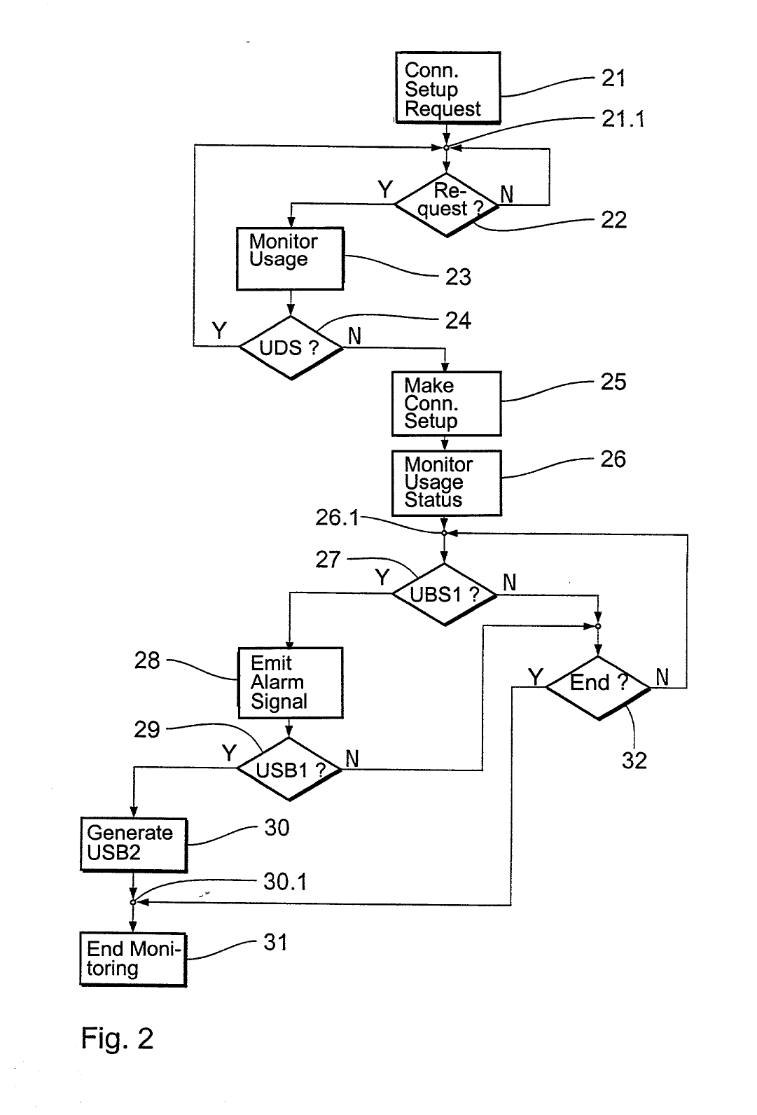

FIG. 2 shows a flow chart of a preferred version of the inventive method for the operation of the postage meter machine 2 that again illustrates the method sequence.

In a step 21, a request for a connection setup to the data center 7 arrives in the processing unit 11 of the postage meter machine 2. This request can have been generated by the postage meter machine 2 itself dependent on specific criteria or can have been entered as an input by a user of the postage meter machine 2.

After checking for the presence of such a request in step 22, the processing unit 11 in step 23 initiates monitoring of the usage status of the telephone line 4 by the monitoring device 14.

In step 24, the processing unit 11 checks whether a suppression signal UDS of the monitoring device 14 is present at its input 11.1. If this is the case, a branch is made back to point 21.1, and thus to the step 22.

If, however, this is not the case, i.e. when the corresponding channel of the telephone line 4 is not being used at this time, the processing device 11 in step 25 initiates the connection setup to the data center 7 by suitably driving the modem 12.

In step 26, the processing unit 11 again initiates monitoring of the usage status of the telephone line 4 by the monitoring device 14, this monitoring ensuing at short time intervals.

In step 27, the processing unit 11 checks whether a first interrupt signal UBS1 of the monitoring device 14 is present at its input 11.1. In otherwords, a check is made to determine whether an attempt is being made by the telephone 8 to setup a connection to the telephone network 5.

If this is the case, the processing unit 11 in step 28 drives the signal device 15 to emit the alarm signal and, in step 29 following the time delay, a renewed check ensues in step 29 to determine whether a first interrupt signal UBS1 of the monitoring device 14 continues to be present at its input 11.1.

If this is the case, the processing unit 11 in step 30 generates a second interrupt signal UBS2 and initiates the transmission thereof to the data center 7 via the existing connection.

Finally, the processing unit 11 in step 31 initiates the abort of the connection to the data center 7 by again suitably driving the modem 12. The connection is then aborted and the telephone line 4 can be used by the telephone 8.

In the step 31, moreover, the processing unit 11 also initiates the end of the monitoring of the usage status of the telephone line 4 by the monitoring device 14 by suitably driving the monitoring device 14.

If, in contrast, no first interrupt signal is present at the input 11.1 of the processing unit 11 in the step 27, the processing unit 11 in step 32 checks whether the data transmission to the data center has already ended. The same ensues, moreover, when a first interrupt signal is no longer present at the input 11.1 of the processing unit 11 in the step 29, i.e. when the user of the telephone has hung up, and, accordingly, a branch is made to point 27.1.

If the check in step 32 shows that the data transmission has not yet ended, a branch is made back to the point 26.1, and thus to step 27.

If the check in step 32 indicates instead that the data transmission has ended, a branch is made to the point 30.1, and thus to step 31 wherein the connection to the data center is ended.

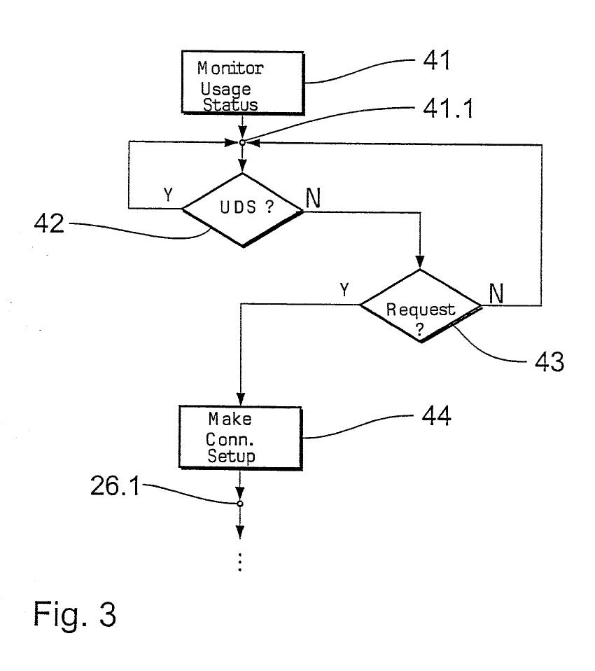

FIG. 3 shows a part of a flow chart of another preferred version of the inventive method that can likewise be realized with the postage meter machine 2 of FIG. 1.

In this version, the processing unit 11 in step 41 initiates the continuous monitoring of the usage status of the telephone line 4 by the monitoring device 14.

In step 42, the processing unit 11 checks whether a suppression signal UDS of the monitoring device 14 is present at its input 11.1. If this is the case, a branch is made back to the point 41.1, and thus to step 22.

If this is not the case, a check is made in step 43 in the processing unit 11 of the postage meter machine 2 to determine whether a request for a connection setup to the data center 7 is present. This request again can have been generated by the postage meter machine 2 itself dependent on specific criteria or can have been entered as an input by a user of the postage meter machine 2.

If this is not the case, a return is made to the point 41.1, and thus to step 22.

If, however, a request for a connection setup to the data center 7 is present in step 43, the processing unit 11 in step 44 initiates the connection setup to the data center 7 by suitably driving the modem 12. Beginning at point 26.1, subsequent procedures are like those described for FIG. 2.

The invention has been described above such that a fixed allocation of the postage meter machine and the telephone 8 exists for the one channel of the telephone line 4. It is self-evident that the other telecommunication devices 9 and 10 also can be allocated to this channel or—given a normal telephone connection—that only a single such channel may be present. The activities of the other telecommunication devices 9 and 10 can then be acquired and taken into consideration in the same way as the telephone 8.

The invention was also described above such that a fixed allocation of the postage meter machine 2 and of the further telecommunication devices 8 through 10 exists to the individual channels of the telephone line. It is self-evident, however, that such a fixed allocation need not be present in other versions. The monitoring device can then be fashioned such that it monitors all existing channels and only suppresses the connection setup if none of the channels is free. Likewise, it can be fashioned such that it only suppresses the existing connection to the data center if no free channel is present.

The invention was described above on the basis of a postage meter machine with a modem 12 and monitoring device 14 as separate units. However, these units can be structurally integrated in a shared unit, as is the case, for example, in the Si2400 ISOmodem™ of Silicon Laboratories, Inc., Austin, Tex., USA.

Although modifications and changes may be suggested by those skilled in the art, it is in the intention of the inventors to embody within the patent warranted hereon all changes and modifications as reasonably and properly come within the scope of their contribution to the art.

We claim as our invention:

1. A postage meter machine comprising:
a processing unit;
a data transmission device connected to said processing unit and adapted for transmitting information between said processing unit and a remote data center via a telecommunication network;
said data transmission device including a connection arrangement for making a communication connection to a telecommunication line of said telecommunication network;
a monitoring device connected to said processing unit for monitoring a usage status of said telecommunication line and for providing usage status information to said processing unit; and
said processing unit controlling a connection setup to said telecommunication network by said data transmission device dependent on said usage status information.

2. A postage meter machine as claimed in claim 1 wherein usage of said telecommunication line is shared by said data transmission device and a further telecommunication device, and wherein said processing unit suppresses setup of said connection by said data transmission device if said usage status information indicates that said telecommunication line is in use by said further telecommunication device.

3. A postage meter machine as claimed in claim 2 wherein said usage status information includes a suppression signal generated by said monitoring device.

4. A postage meter machine as claimed in claim 1 wherein usage of said telecommunication line is shared by said data transmission device and a further telecommunication device, and wherein said monitoring device identifies an attempt at a connection setup via said telecommunication line by said further telecommunication device, and includes information identifying said attempt in said usage status information.

5. A postage meter machine as claimed in claim 4 wherein said monitoring device generates an interrupt signal in said usage status information upon identification of said attempt, and wherein said processing unit, upon receiving said interrupt signal, causes said data transmission device to interrupt use of said telecommunication line.

6. A postage meter machine as claimed in claim 5 wherein said interrupt signal is a first interrupt signal, and wherein said monitoring device, upon receiving a control signal from said processing unit to interrupt said use of said telecommunication line by said data transmission device, generates a second interrupt signal and transmits said second interrupt signal to said data center via said telecommunication line before interrupting said connection.

7. A system for communicating between a data center and a postage meter machine, comprising:
a postage meter machine having a processing unit;
a data center located remote from said postage meter machine;
a data transmission device connected to said processing unit and adapted for transmitting information between said processing unit and said data center via a telecommunication network;
said data transmission device including a connection arrangement for making a communication connection to a telecommunication line of said telecommunication network;
a monitoring device connected to said processing unit for monitoring a usage status of said telecommunication line and for providing usage status information to said processing unit; and
said processing unit controlling a connection setup to said telecommunication network by said data transmission device dependent on said usage status information.

8. A system as claimed in claim 7 wherein said telecommunication line is shared by said data transmission device and a further telecommunication device, and wherein said monitoring device identifies an attempt at a connection setup via said telecommunication line by said further telecommunication device and includes a first interrupt signal in said usage status information supplied to said processing unit, and wherein said processing unit, upon receiving said first interrupt signal, supplies a control signal to said data transmission device instructing said data transmission device to interrupt said connection, and wherein said data transmission device, upon receipt of said control signal, generates a second interrupt signal and transmits said second interrupt signal to said data center via said telecommunication line before interrupting said connection.

9. A method for controlling communication between a postage meter machine and a remote data center via a communication network having a telecommunication line shared by the postage meter machine and a further telecommunication device, said method comprising the steps of:
providing a postage meter machine with a processing unit and a data transmission device connected to said processing unit, and transmitting information between said processing unit and a remote data center via a telecommunication network;
including in said data transmission device a connection arrangement for making a communication connection to a telecommunication line of said telecommunication network;
with a monitoring device connected to said processing unit, monitoring a usage status of said telecommunication line and providing usage status information to said processing unit; and
controlling, via said processing unit, a connection setup to said telecommunication network by said data transmission device dependent on said usage status information.

10. A method as claimed in claim 9 wherein usage of said telecommunication line is shared by said data transmission device and a further telecommunication device, and, via said processing unit, suppressing setup of said connection by said data transmission device if said usage status information indicates that said telecommunication line is in use by said further telecommunication device.

11. A method as claimed in claim 10 comprising including a suppression signal generated by said monitoring device in said usage status information.

12. A method as claimed in claim 9 wherein usage of said telecommunication line is shared by said data transmission device and a further telecommunication device, and comprising identifying, via said monitoring device, an attempt at a connection setup via said telecommunication line by said further telecommunication device, and including information identifying said attempt in said usage status information.

13. A method as claimed in claim 12 comprising including an interrupt signal in said usage status information upon identification of said attempt, and said processing unit, upon receiving said interrupt signal, causing said data transmission device to interrupt use of said telecommunication line.

14. A method as claimed in claim 13 wherein said interrupt signal is a first interrupt signal, and comprising generating a second interrupt signal in said monitoring device, upon receiving a control signal from said processing unit to interrupt said use of said telecommunication line by said data transmission device, and transmitting said second interrupt signal to said data center via said telecommunication line before interrupting said connection.
